(19) United States
(12) Patent Application Publication
(10) Pub. No.: US 2012/0173267 A1
(43) Pub. Date: Jul. 5, 2012

(54) Database System for Medical Back-Office

(76) Inventor: Julian Omidi, Las Vegas, NV (US)

(21) Appl. No.: 13/341,921

(22) Filed: Dec. 31, 2011

Related U.S. Application Data
(60) Provisional application No. 61/428,988, filed on Dec. 31, 2010.

(51) Int. Cl. G06Q 50/22

(52) U.S. Cl. 705/2

(57) ABSTRACT

The present invention is comprised of a database system for medical back office for managing the day to day and long term operations of one or more outpatient surgery center or other type of health care facility such as a hospital. The present invention is further comprised of a customizable modular programming structure configured to perform fast processing of vast amounts of data providing comprehensive data search retrieval with flexible filtering by any data field or multiple data fields using one or more component module that quickly interface with the existing program structure and jointly operate with the other multi-tasking functions on a real-time basis.

### BACKGROUND

The days of the country doctor traveling around in a horse drawn buggy keeping patient notes in a small journal are just memories of a by-gone era. The current health care industry is just that an industry. Population growth, extended life spans and greater public awareness of health care issues has made it one of the fastest growing sectors in the economy.

The health care industry in the United States alone employs millions of workers that include health care professionals, technicians and administrative personnel. It treats hundreds of millions of patients annually. It requires tens of billions of investment dollars to create the infrastructure that includes hospitals, clinic, surgical centers and multi-million dollar pieces of equipment. The financial impact of the services provided amounts to hundreds of billions of dollars coming from patients, insurance companies and government programs.

The shear volume of patients, treatments and procedures confronting medical and surgical organizations is an administrative challenge. The numbers of agencies that mandate tight monitoring controls and regulations covering every aspect of the services including for example controlled substances, professional credentials, equipment usage and maintenance, detailed record keeping of patient medical history and condition before, during and post treatment compounds the complexity of the administrative responsibilities.

In addition the financial process of getting paid for the services must deal with hundreds of insurance companies, each with multiple health plans that contain myriads of qualifying conditions for health care and surgical centers to receive payment for each medication, treatment and procedure. The availability of a wide range of government funded health care programs covers in whole or in part the patient pool of hundreds of millions of people. Each government funded health care program also has layers of qualifying conditions for health care and surgical centers to receive payment for each medication, treatment and procedure.

Unfortunately for health care and surgical centers this is not a static situation. New programs, insurance plans, monitoring controls and regulations come upon the scene each year to match the advances and specialized discoveries in medical treatments, medications, procedures and equipment. Cost saving consolidations of facilities and organizations increases the monumental tasks of record keeping, scheduling, reporting and billing to allow these services to maintain financial viability, the quality of care and not let any detail slip through the cracks.

Improvements in current computer technologies have provided a level of assistance through new hardware to be able handle the hundreds of billions of transactions and data collection. The advanced hardware benefits can only be tapped by a user if the programming and software that controls its use are equally advanced.

Currently health care industry organizations have available multiple software packages that provide specialized use for only one facet of their operation. Many of the software packages cannot integrate with others used for other functions. Many are not structured to handle data input and retrieval from multiple facilities, particularly remote facilities that can make up the health care and surgical centers organization.

The use of stand-alone non-integrated software cost health care and surgical center organizations millions of dollars annually. These avoidable costs include for example additional personnel, training, late or missing treatment and procedure billings, expiration of mandated credential and qualifying certifications causing disruptions in services and risk of loss of accreditation. The lack of a comprehensive system that can include all of the aspects of the organizations operations, cross-referencing, checks and balances provided with automated scheduling and action alerts can put the organization at risk for indefensible litigation because of the lack of supportive documentation. The present invention answers the call for a fully integrated programmable database system that is adaptable to include customized and additional features, process the massive volumes of data and multi-tasking functions on a real-time basis for a single or multifacility health care organization.

### BRIEF DESCRIPTION OF THE DRAWINGS

FIG. 1 shows a block diagram of an overview of a database system for medical back office of one embodiment of the present invention.

FIG. 2 shows a block diagram of an overview flow chart example of the database system for medical back office of one embodiment of the present invention.

FIG. 3 shows a block diagram of an overview flow chart example of the database system for medical back office data entry log module selection of one embodiment of the present invention.

FIG. 4 shows a block diagram of an overview flow chart example of the database system for medical back office miscellaneous forms of one embodiment of the present invention.

FIG. 5 shows a block diagram of an overview flow chart example of the database system for medical back office security features of one embodiment of the present invention.

FIG. 6 shows a block diagram of an overview flow chart example of the database system for medical back office automated real time usage tracking system of one embodiment of the present invention.

FIG. 7 shows a block diagram of an overview flow chart example of the database system for medical back office automated data input integrity filter of one embodiment of the present invention.

FIG. 8A shows a block diagram of an overview flow chart example of the database system for medical back office billing database log of one embodiment of the present invention.

FIG. 8B shows a block diagram of an overview flow chart example of the database system for medical back office automated schedule tracking module of one embodiment of the present invention.

FIG. 9A shows a block diagram of an overview flow chart example of the database system for medical back office pre-op log of one embodiment of the present invention.

FIG. 9B shows a block diagram of an overview flow chart example of the database system for medical back office bariatric pre-op log of one embodiment of the present invention.

FIG. 10 shows a block diagram of an overview flow chart of an example of the database system for medical back office management administrative reporting module of one embodiment of the present invention.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview:

It should be noted that the descriptions that follow, for example, in terms of database system for medical back office is described for illustrative purposes and the underlying system can apply to any number and multiple types of database system for medical back office functions. In one embodiment of the present invention, the database system for medical back office may include function modules to service a single surgery center. The database system for medical back office can be configured to include function modules and capabilities to service multiple surgery centers and can be configured to interact with external software used in for example an individual medical office or other forms, modules, formats, functions and interactive modes using the present invention.

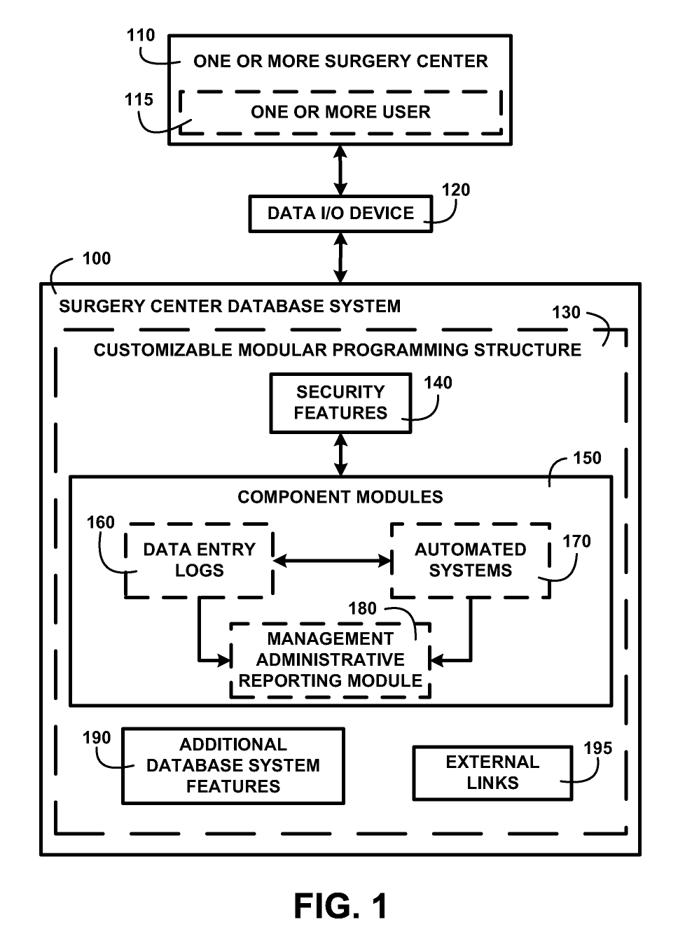

FIG. 1 shows a block diagram of an overview of a database system for medical back office of one embodiment of the present invention. FIG. 1 shows a database system for medical back office 100 which is a multi-faceted software system configured to manage one or more outpatient surgery center 110 or other type of health care facility such as a hospital. The surgery center database system 100 can be configured to provide a full range of services for one or more outpatient surgery center 110 operation including for example record keeping, scheduling and tracking of patient care, compliance reporting, staffing, billing, supplies and equipment maintenance and testing of one embodiment of the present invention.

One or more outpatient surgery center 110 each with one or more user 115 can each easily generate vast amounts of data. Hundreds of staff members at each of the one or more outpatient surgery center 110 are providing health care to thousands of patients. Each element of each phase of each treatment or procedure must be accurately recorded and is reported multiple times to the numerous agencies regulating the center and insurance companies making payments for the health care services. The numbers of treatments, procedures and transactions are in the millions. The staff can perform their duties well only by having real time updated information of treatments and procedures being performed by each department and other staff members. The lack of accurate up to date information can endanger patients and create liability for the facility and organization. The management responsible for the operations including the financial condition must be able to monitor every aspect of the center. The surgery center database system 100 provides the real time access to all center activities data to produce the administrative tools to judge performance and manage the complexity of the various operations of one embodiment of the present invention.

The surgery center database system 100 is configured as a customizable modular programming structure 130. The customizable modular programming structure 130 is capable of fast processing of vast amounts of data providing comprehensive data search retrieval with flexible filtering by any data field or multiple data fields. The customizable modular programming structure 130 is configured with multi-level security features 140 to protect patient privacy and protect unauthorized access to the database, component modules 150 and make changes in data entries. Authorized users can access the surgery center database system 100 through a data I/O device 120. The customizable modular programming structure 130 can be configured with component modules 150. Additional or customized component modules 150 can easily be integrated into the customizable modular programming structure 130 allowing new additions to quickly interface with the existing program structure and jointly operate with the other multi-tasking functions on a real-time basis of one embodiment of the present invention.

The component modules 150 can include for example data entry logs 160, automated systems 170 and management administrative reporting module 180. The data entry logs 160 can be configured for example to include a pre-op log, OR temperature log, narcotics log, billing database log, credentials log and equipment inventory log. The data entry logs 160 can be customized for any type of specialized practice or management purposes of one embodiment of the present invention.

The automated systems 170 harness the power of current computer technology by performing the billions of processes to maintain the cross referenced accurate real time updated information the staff uses. The automated systems 170 can be configured for example to include checking data entries for conformance with field variable parameters in real time, tracking patient conditions and progress for insurance company reports, tracking compliance with regulations of controlled substances, completing equipment scheduled maintenance and other operational functions. The automated systems 170 can be configured to send alert notifications for example by email to designated staff or displayed on a terminal display screen when designated staff login that data entry errors have occurred including the user who entered the data, the type of data and type of error of one embodiment of the present invention.

The management administrative reporting module 180 performs tracking of all sectors of the operations. The management administrative reporting module 180 can include for example customized automated systems 170 to extract data from various data entry logs 160 to produce requested reports that can automatically calculate performance evaluations. These reports can include a billings and receivables status for treatments or procedures, performance evaluations for individual staff members, forecasting and historical measurements of the various aspects of the operations of one embodiment of the present invention.

The database system for medical back office 100 can be configured to include additional database system features 190 for example remote accessing through standard remote desktop protocol, real-time tracking of usage by time, staff, module and changes made, front-end access, back-end access and SQL 95. The database system for medical back office 100 can be configured to include multiple external links 195 for example that can link to internet mail servers, teleconferencing and link to existing practice managers to transfer patient information of one embodiment of the present invention.

Constant changes due to for example new medical procedures, expanding regulation compliance reporting and detail demanding insurance processing make the adaptive customizable features of the surgery center database system 100 indispensable. The surgery center database system 100 provides health care organizations with a fast flexible and accurate system allowing them to manage the vast amounts of record keeping, scheduling, reporting and billing on a real-time basis and assist in the delivery of quality health care services to their patients of one embodiment of the present invention.

### Detailed Operation:

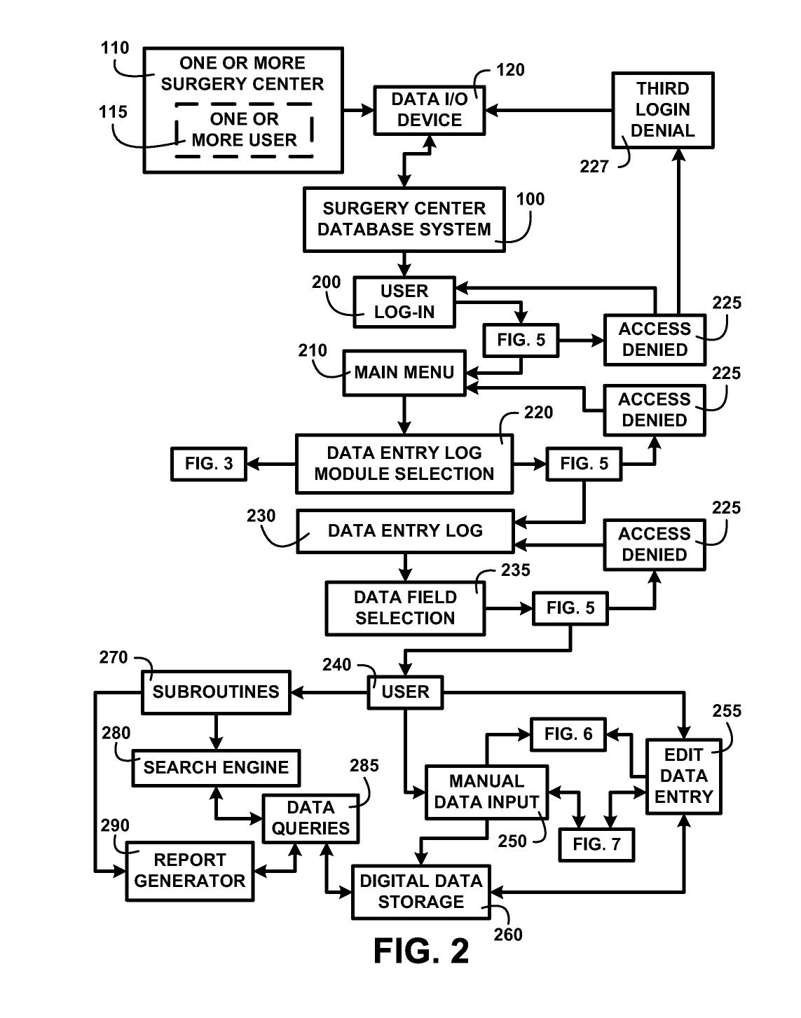

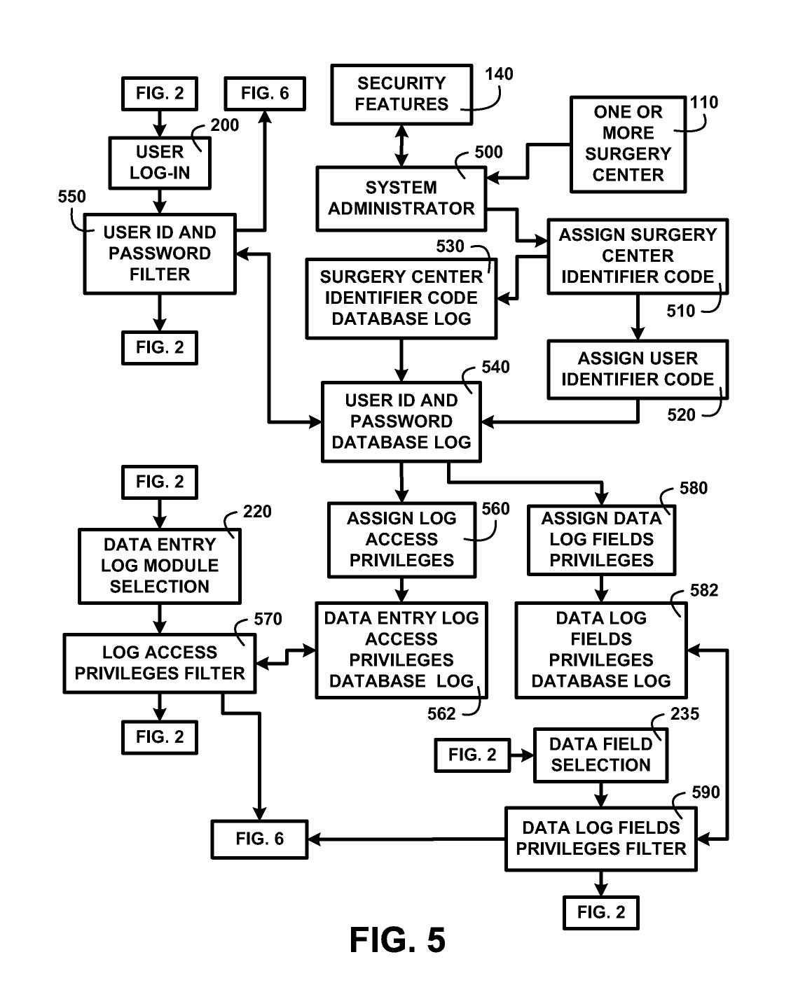

FIG. 2 shows a block diagram of an overview flow chart example of the surgery center database software of one embodiment of the present invention. FIG. 2 shows the surgery center database system 100 which can be accessed by one or more surgery center 110 having one or more user 115 using a data I/O device 120. A user log-in 200 is routed through the security features 140 of FIG. 1 in processes that continue and are discussed in detail in FIG. 5 then returns an authorized user 240 to a main menu 210. If wrong login information is entered the user 240 is twice shown an access denied 225 message and if a third user log-in 200 results in a third login denial 227 the user 240 is disconnected from the surgery center database system 100 of one embodiment of the present invention.

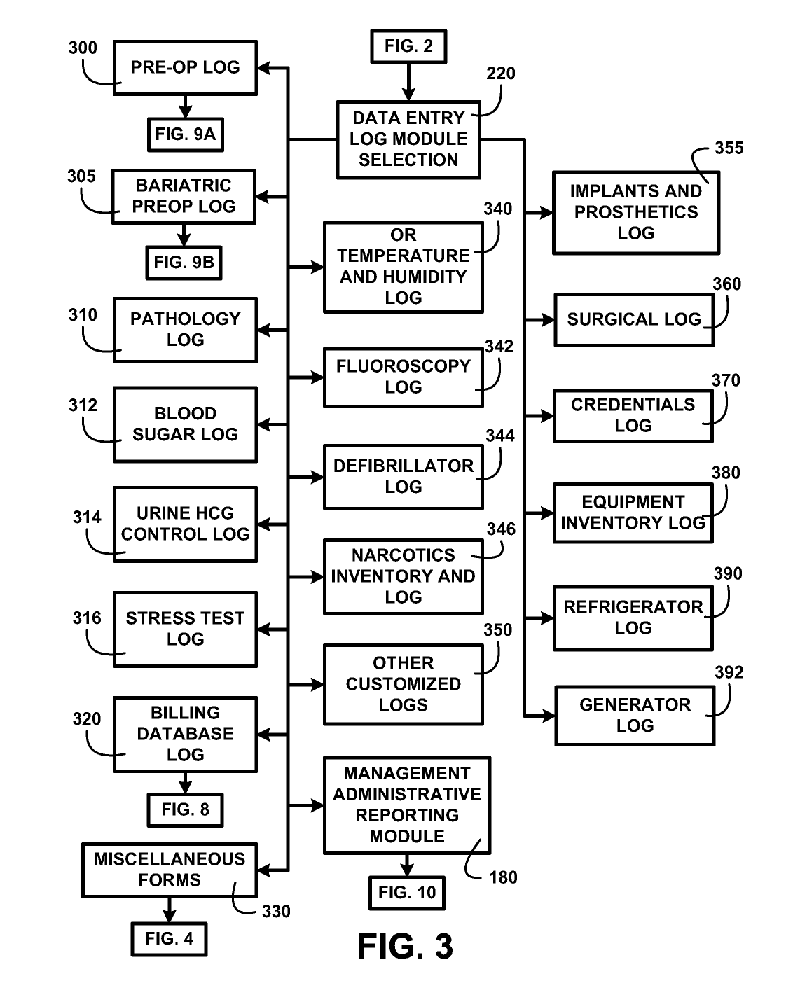

The main menu 210 displays on the user 240 monitor a list for a data entry log module selection 220. The main menu 210 list is discussed in detail in FIG. 3 which follows. The user 240 makes the desired data entry log module selection 220 which is routed through the security features 140 of FIG. 1 in processes that continue and are discussed in detail in FIG. 5 then returns an authorized user 240 actions to the desired data entry log 230. If the user 240 is not authorized to access the desired data entry log 230 an access denied 225 message is displayed and the user 240 returned to the main menu 210 of one embodiment of the present invention.

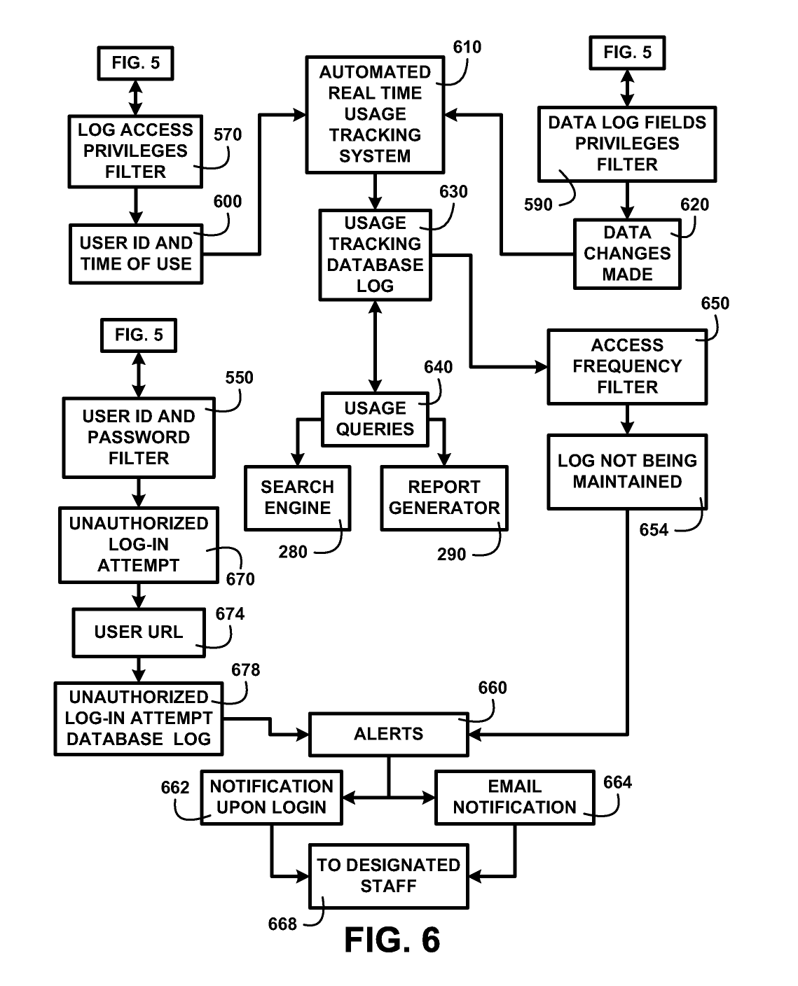

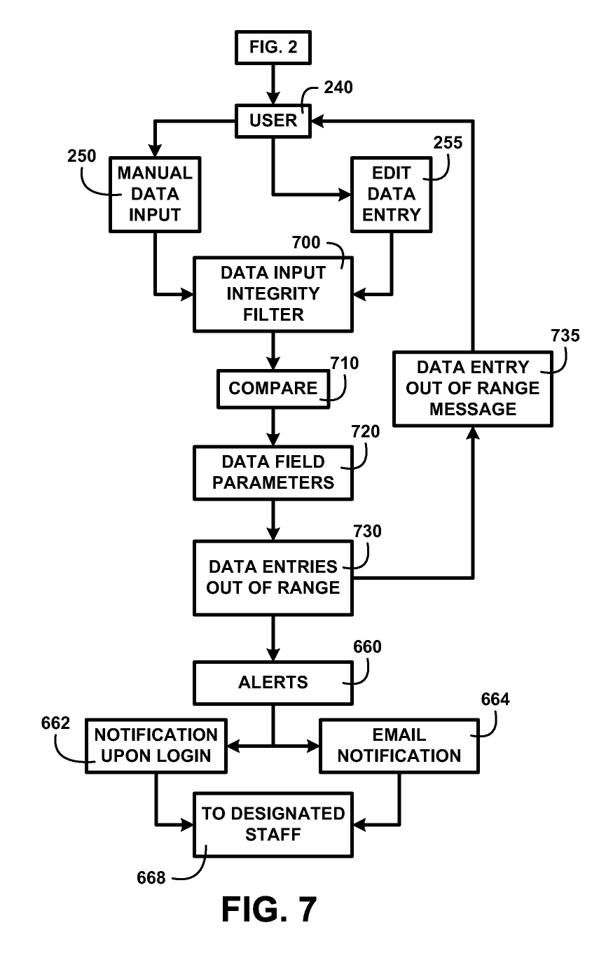

Upon access to the desired data entry log 230 when the user 240 makes a data field selection 235 it is routed through the security features 140 of FIG. 1 in processes that continue in FIG. 5 then returns an authorized user 240 to the data field selection 235 to complete the transaction. If the user 240 is not authorized to access the desired data field selection 235 an access denied 225 message is displayed and the user 240 returned to the data entry log 230. An authorized user 240 can perform manual data input 250 or edit data entry 255 information previously entered. In the background the manual data input 250 or edit data entry 255 information is checked by processes that continue and are discussed in detail in FIG. 7. Additionally in the background the manual data input 250 or edit data entry 255 actions are processed further and are discussed in detail in FIG. 6. The manual data input 250 or edit data entry 255 information accepted by the system is immediately recorded on a digital data storage 260 medium and available for real-time access of one embodiment of the present invention.

An authorized user 240 can access subroutines 270 for example a search engine 280 or a report generator 290. Both the search engine 280 and the report generator 290 process data queries 285 accessing in real-time the digital data storage 260 for desired data field information. The report generator 290 can produce a report can be displayed on a monitor or printed of one embodiment of the present invention.

### Data Entry Log Module Selection:

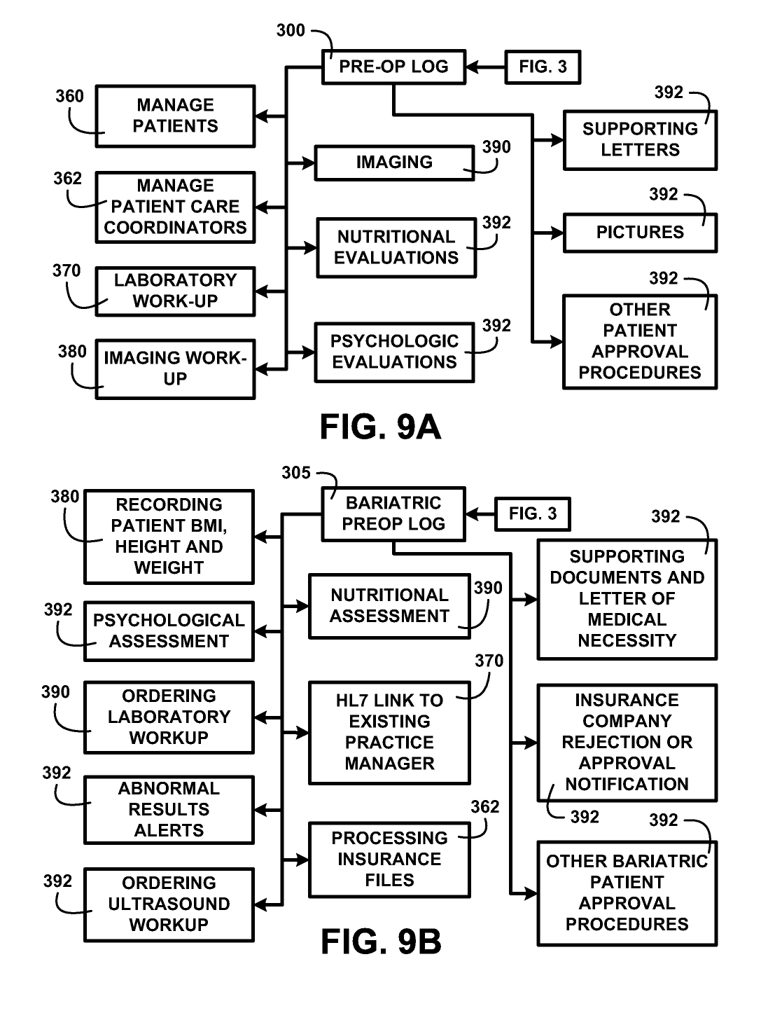

FIG. 3 shows a block diagram of an overview flow chart example of the surgery center database software data entry log module selection of one embodiment of the present invention. FIG. 3 shows an example of the FIG. 2 data entry log module selection 220 accessed by an authorized user 240 of FIG. 2. The surgery center database system 100 of FIG. 1 can be configured to add other customized logs 350 to the main menu 210 of FIG. 2. The data entry log module selection 220 can be configured to include the other customized logs 350 such as specialized data entry logs 160 of FIG. 1 to allow the surgery center staff to better perform their operational duties. Various data entry log 230 files are available for selection for example a pre-op log 300 as discussed in detail with reference to FIG. 9A which follows. A bariatric pre-op log 305 as discussed in detail with reference to FIG. 9B which follows. Also are a pathology log 310 to maintenance of all pathology information sent to pathology lab including information such as for example date sent, date results received and whether results are normal of one embodiment of the present invention.

A blood sugar log 312 records the test values used in all equipment that requires controls for normal values. Many surgery centers facilitate blood sugar testing for patients that are diabetics. The blood sugar log 312 records tests of all control values used for all glucometers in all different surgery centers and all glucose values for all patients. A urine HCG control log 314 all blood/serum/urine tests require control testing and monitoring in any surgery center or hospital. Urine HCG test is used for female patients prior to undergoing a procedure to confirm that they are not pregnant. The urine HCG control log 314 records all tests of all control values for Urine HCG strips. The urine HCG control log 314 can be configured as different logs for different surgery centers of one embodiment of the present invention.

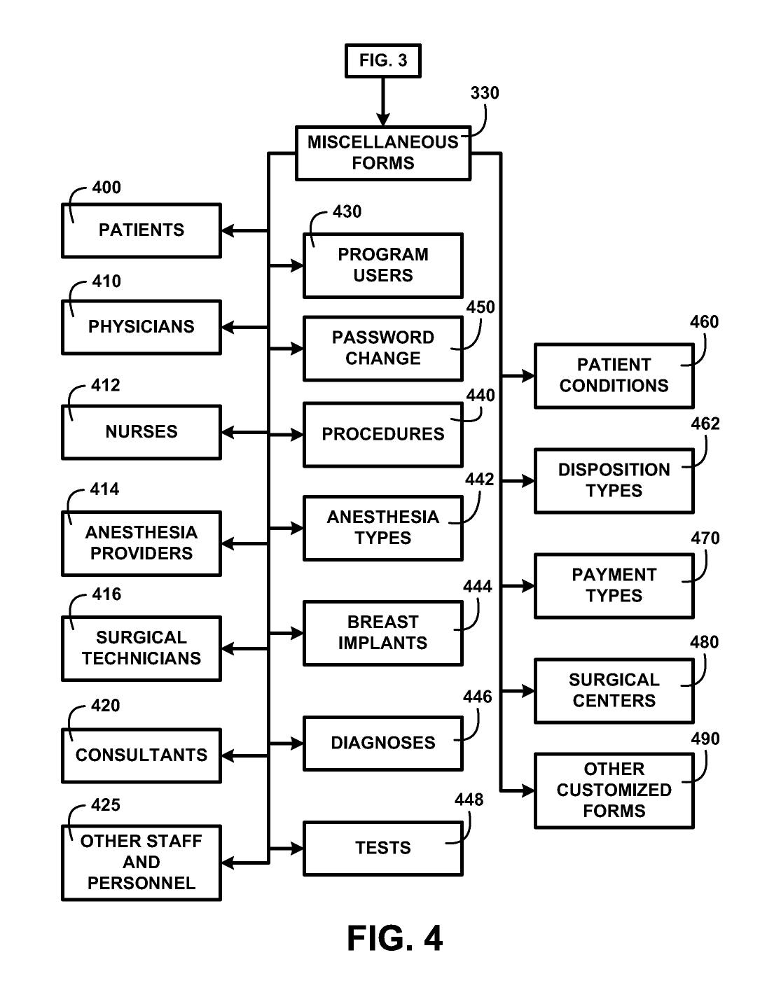

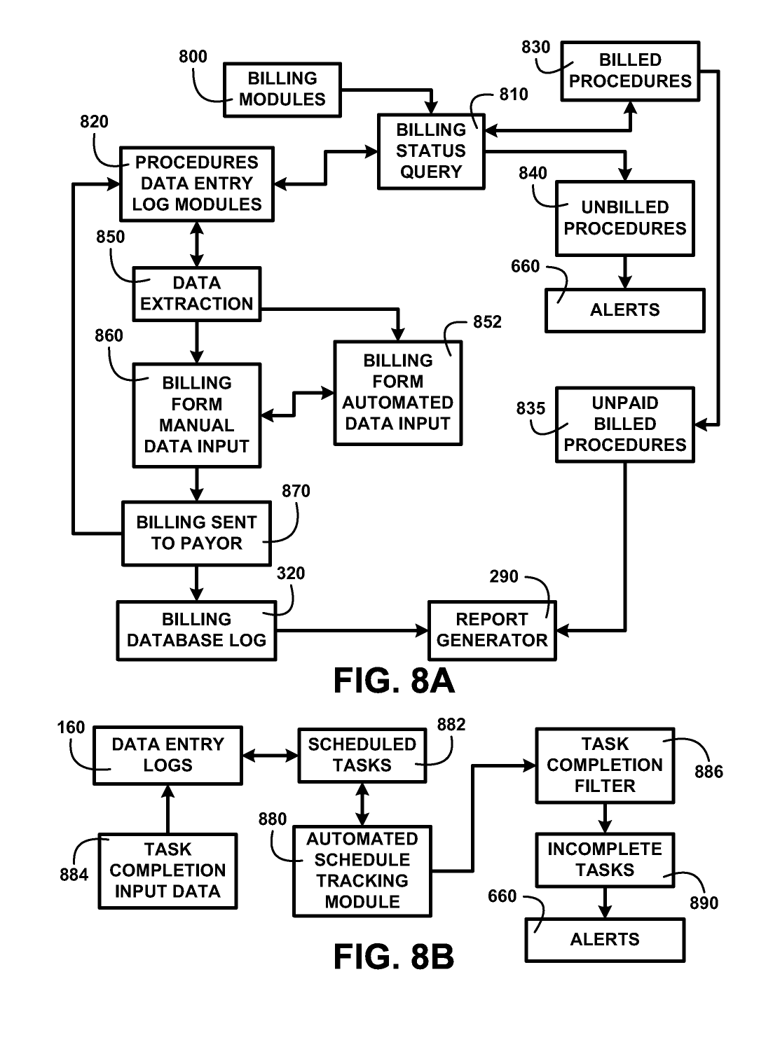

A stress test log 316 records stress testing in a cardiac/echocardiography lab. The stress test log 316 allows maintenance of patient logs undergoing stress test, results of treadmill stress testing, echocardiography post stress testing and final results from cardiologist and radiologist. The stress test log 316 maintains final risk stratification from cardiologist. A billing database log 320 as discussed in detail with reference to FIG. 8A which follows. A miscellaneous forms 330 module as discussed in detail with reference to FIG. 4 which follows. Surgery centers need to maintain accurate records of humidity and temperature of all operatory suites for infection control purposes. An OR temperature and humidity log 340 module records all temperature and humidity levels of all different operatory suites in one or more surgery center or hospital. A fluoroscopy log 342 module records patient information with ID and name, procedures performed, pre-procedure and post-procedure diagnosis and time spent in fluoroscopy as related to radiation dosage. A defibrillator log 344 maintains records of all defibrillators in one or more surgery center or hospital. The defibrillator log 344 includes the date tested, record of nurse testing the equipment, the amount of Joules used for test and the results and produces notifications of abnormal results and incomplete tests of one embodiment of the present invention.

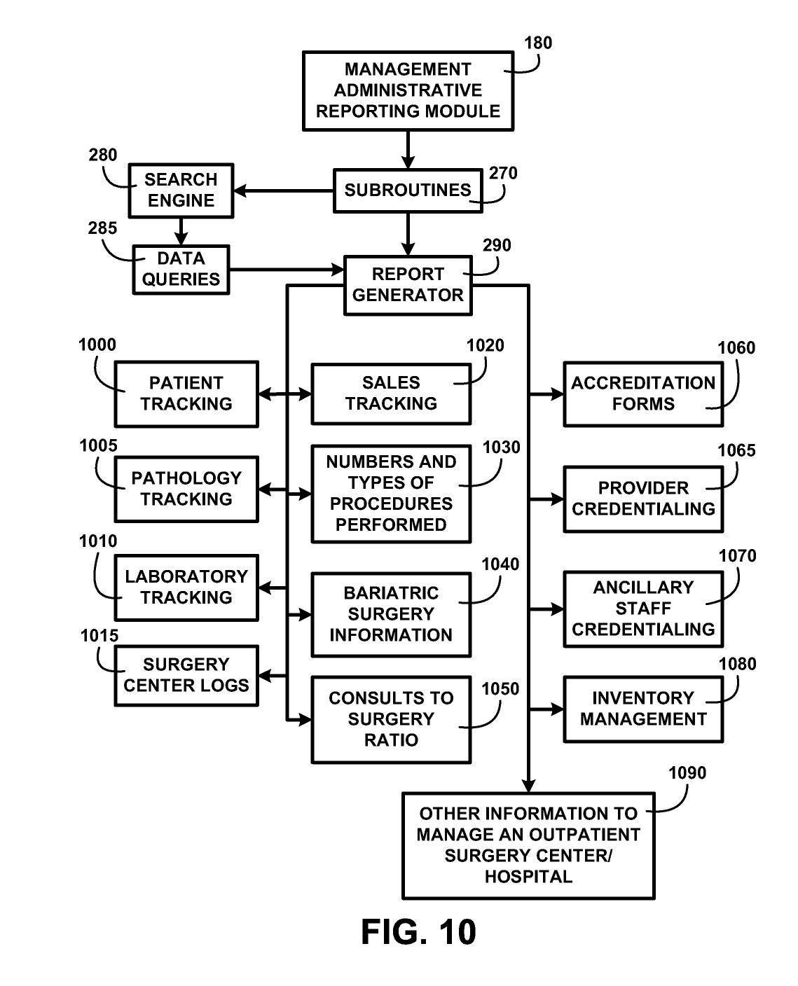

A narcotics inventory and log 346 allows accurate maintenance of an inventory inventory and log 346 provides accurate logging of dispersal of narcotics to various practitioners and dispersal to according patients. The narcotics inventory and log 346 can be configured with automated systems 170 of FIG. 1 to produce reconciliation of AM and PM counts based on usage and issue alert when at minimum par levels. The management administrative reporting module 180 as discussed in detail with reference to FIG. 10 which follows of one embodiment of the present invention.

An implants and prosthetics log 355 records and tracks all items that the surgery center would order and use on patients. The implants and prosthetics log 355 can be customized for general inventory of any item. The implants and prosthetics log 355 records for example the serial numbers of the items, the date it was used, the patient that used it, starting and ending counts. The implants and prosthetics log 355 module can be customized for example to include prewritten software for breast implants such as serial number, profile, size and number in inventory for example supplied by a manufacturer and prewritten modules for orthopedic and podiatric implants of one embodiment of the present invention.

A surgical log 360 can be configured as a module that includes a powerful collection of software programming integrated into one module that includes a registry of surgeries performed in the surgical suites. The surgical log 360 can be configured to many other features related to surgeries performed such as for example a patient registry, OR tracking time, discharge tracking time, notification of incomplete records, procedure and pre-operative and post-operative diagnosis, summary of numbers of procedures defined as multiple procedures on one patient and surgeries defined as one patient and one anesthetic in any period of time, calculation of average OR times for anesthesia providers and surgeons, staff allocation and operatory allocation of one embodiment of the present invention.

Certifying agencies require the credentialing of all staff and maintenance of all records. A credentials log 370 maintains all forms in EMR for all practitioners and ancillary staff in one or multiple surgery center/hospitals. The credentials log 370 can include multiple modules for physicians, anesthesia providers, OR staff and other ancillary staff. The credentials log 370 can include EMR and tracking of all of the credentialing data. The credentialing data can include for example AMA verification date and results, NPDB verification date and results, DEA expiration date, liability insurance commencement and expiration, initiation of privileges date, status of license, States license is active in, ACLS certification and expiration, Board Certification, Date of certification and expiration, Curriculum Vitae, References, CME and hours completed, History and Physical exam and expiration, PPD and X-ray results and test, HIV Hepatitis waver and date/expiration, Service Date and Expiration, Hospital Privileges and date of expiration. The credentials log 370 maintains records that can include for example renewal filings information such as application date, type of license verification type and the date of license certification and expiration of one embodiment of the present invention.

An equipment inventory log 380 records a detailed log of all equipment in one or multiple surgery centers that can include for example the location of equipment, type of equipment, description of type of equipment, serial number, indication of daily checks, indication of equipment being functional or non-functional, a text box for narrative descriptions of working or non-working status, service date with automatic reminder on next service date and additional notes. Surgery centers and hospitals store medications that require strict temperature control. One of the requirements for accreditation with all certifying bodies is the maintenance of accurate temperature of all refrigerators storing medications in a hospital or surgery center. A refrigerator log 390 maintains records that can include for example temperature of all refrigerators for all different surgery centers. A generator log 392 maintains information of all generators in one or more surgery center 110 of FIG. 1, date tested, a record of staff testing equipment, the amount of joules used for test and the results and can automatically produce notifications of abnormal results and incomplete tests of one embodiment of the present invention.

### Miscellaneous Forms:

FIG. 4 shows a block diagram of an overview flow chart example of the surgery center database software miscellaneous forms of one embodiment of the present invention. FIG. 4 shows the miscellaneous forms 330 module shown in FIG. 3. The forms in the miscellaneous forms 330 module are displayed electronically for user 240 input and the data entered is stored on the digital data storage 260 of FIG. 2 and can also be printed. The miscellaneous forms 330 standardize field data input and identification to allow fast access in the real-time operating environment of the surgery center database system 100 of FIG. 1 of one embodiment of the present invention.

The miscellaneous forms 330 module can be configured to include forms to record information regarding patients 400, physicians 402, nurses 404, anesthesia providers 406, surgical technicians 408, consultants 420, and other staff and personnel 425. The miscellaneous forms 330 module can be configured to include forms to record information about program users 430, password change 450, procedures 440, anesthesia types 442, breast implants 444, diagnoses 446, tests 448, patient conditions 460, disposition types 462, payment types 470, surgical centers 480 and other customized forms 490 of one embodiment of the present invention.

### Security Features:

FIG. 5 shows a block diagram of an overview flow chart example of the surgery center database software security features of one embodiment of the present invention. FIG. 5 shows examples of the security features 140 that maintain patient information privacy and the system integrity of the surgery center database system 100 of FIG. 1. The security features 140 allow the system administrator 500 to manage the security elements of one or more surgery center 110 such as the ability to assign a surgery center identifier code 510 to each center. The system administrator 500 can assign a user identifier code 520 to each of the one or more user 115 of FIG. 1. The identifier codes are recorded in a surgery center identifier code database log 530 and a user id and password database log 540 of one embodiment of the present invention.

In a continuation of the processes of FIG. 2 when a user log-in 200 is entered it is routed through a user id and password filter 550. The user id and password filter 550 checks the user log-in 200 with the information recorded in the user id and password database log 540 to verify that the user 240 of FIG. 2 has been authorized for access to the surgery center database system 100 of FIG. 1. The results of the user id and password filter 550 are returned to the processes of FIG. 2. All user log-in 200 events are routed to an automated real time usage tracking system as discussed in detail with reference to FIG. 6 which follows of one embodiment of the present invention.

The system administrator 500 can assign log access privileges 560 to each of the one or more user 115 of FIG. 1. The log access privileges 560 are recorded in a data entry log access privileges database log 562. In a continuation of the processes of FIG. 2 when a user 240 of FIG. 2 makes a data entry log module selection 220 it is routed through a log access privileges filter 572. The log access privileges filter 572 checks the log access privileges 560 with the information recorded in the data entry log access privileges database log 562 to verify that the user 240 of FIG. 2 has been authorized for access to the data entry log 230 of FIG. 2. The results of the log access privileges filter 572 are returned to the processes of FIG. 2. All log access privileges filter 572 events are routed to an automated real time usage tracking system as discussed in detail with reference to FIG. 6 which follows of one embodiment of the present invention.

The system administrator 500 can assign data log fields privileges 580 to each of the one or more user 115 of FIG. 1. The data log fields privileges 580 are recorded in a data log fields privileges database log 582. In a continuation of the processes of FIG. 2 when a user 240 of FIG. 2 makes a data field selection 235 it is routed through a data log fields privileges filter 590. The data log fields privileges filter 590 checks the data log fields privileges 580 with the information recorded in the data entry log access privileges database log 562 to verify that the user 240 of FIG. 2 has been authorized for access to the data field selection 235. The results of the data log fields privileges filter 590 are returned to the processes of FIG. 2. All data log fields privileges filter 590 events are routed to an automated real time usage tracking system as discussed in detail with reference to FIG. 6 which follows of one embodiment of the present invention.

### Automated Real Time Usage Tracking System:

FIG. 6 shows a block diagram of an overview flow chart example of the surgery center database software automated real time usage tracking system of one embodiment of the present invention. FIG. 6 shows the continuation of log access privileges filter 570 15 events from FIG. 5 wherein a user id and time of use 600 is processed in an automated real time usage tracking system 610. FIG. 6 further shows the continuation of data log fields privileges filter 590 events from FIG. 5 wherein data changes made 620 are processed in the automated real time usage tracking system 610. The user id and time of use 600 and data changes made 620 are recorded in a usage tracking database log 630. The records in the usage tracking database log 630 can be accessed in real-time by the system administrator 500 of FIG. 5 using usage queries 640 with the search engine 280 to produce for example usage patterns or types of data being changed and send the results to the report generator 290 of one embodiment of the present invention.

An access frequency filter 650 calculates data entry logs 160 of FIG. 1 access frequency results to identify any log not being maintained 654. The access frequency results that identify any logs not being maintained properly automatically sends alerts 660 to designated staff 668 for investigation. The alerts 660 can be configured to be sent for example as a notification upon login 662 or an email notification 664 using the internet mail server that is included as one of the external links 195 of FIG. 1 of one embodiment of the present invention.

FIG. 6 shows the continuation of processes of FIG. 5 which includes the user id and password filter 550. Every unauthorized log-in attempt 670 that results in a third login denial 227 is tracked and will record the user URL 674 of the user 240 of FIG. 2 that has been disconnected from the surgery center database system 100. The user URL 674 record is stored in an unauthorized log-in attempt database log 678. The unauthorized log-in attempt database log 678 automatically sends alerts 660 to designated staff 668 which can be configured to be the system administrator 500 of FIG. 5 to investigate the identity of the unauthorized user of one embodiment of the present invention.

### Automated Data Input Integrity Filter:

FIG. 7 shows a block diagram of an overview flow chart example of the surgery center database software automated data input integrity filter of one embodiment of the present invention. FIG. 7 shows a continuation of processes in FIG. 2 in which the user 240 is performing manual data input 250 or edit data entry 255. The data information entered by the user 240 is routed through a data input integrity filter 700. The data input integrity filter 700 is used to compare 710 the user 240 data entries to data field parameters 720. The data field parameters 720 can be configured to preset field lengths, type of data such as text, or numeric values that can be limited to a minimum and maximum value. Should a user 240 make data entries out of range 730 or of a type not compatible with the data field parameters 720 a data entry out of range message 735 is displayed on the monitor of the user 240. If the user 240 proceeds to enter the incorrect format of the data the data input integrity filter 700 process sends alerts 660 to designated staff 668 for corrective action. The alerts 660 can be configured to be sent for example as a notification upon login 662 or an email notification 664 using the internet mail server that is included as one of the external links 195 of FIG. 1 of one embodiment of the present invention.

### Billing Database Log:

FIG. 8A shows a block diagram of an overview flow chart example of the database system for medical back office billing database log of one embodiment of the present invention. FIG. 8A shows the continuation of processes in FIG. 2 when the user 240 of FIG. 2 makes a data entry log module selection 220 of FIG. 2 of the billing database log 320 of FIG. 3. The billing database log 320 of FIG. 3 allows the surgery center business operations to for example track with real-time access the various activities which can include medical procedures, treatments and other forms of patient care for which fees can be charged or pending expenses for items such as equipment purchase or medicine inventory replenishment. The billing database log 320 of FIG. 3 can be configured to include billing modules 800. The billing modules 800 is configured to include automated systems 170 of FIG. 1 which includes an automated billing status query 810 module of one embodiment of the present invention.

The billing status query 810 module can be configured to for example extract data field information from component modules 150 of FIG. 1 such as procedures data entry log modules 820. If the billing status query 810 finds a billing sent to payor 870 data field entry recorded indicating billed procedures 830 the billing modules 800 can be configured to check whether the billing for the procedure has been paid. Any unpaid billed procedures 835 can be assembled in the report generator 290 to send alerts 660 to designated staff 668 of FIG. 6 to follow up on collections of one embodiment of the present invention.

When the billing status query 810 finds unbilled procedures 840 a listing can be assembled in the report generator 290 to send alerts 660 to designated staff 668 of FIG. 6 to follow up on billing preparation. One of the automated systems of FIG. 1 can search procedures data entry log modules 820 to perform a data extraction 850 and complete for example a billing form automated data input 852 which can enter automatically data included in the billing form for that procedure. The billing form automated data input 852 can be configured to include billing form manual data input 860 including for example additional information to complete the bill requested by an insurance company designated in the procedures data entry log modules 820 of one embodiment of the present invention.

Designated staff authorized to prepare billings can proceed to complete the billing and enter billing form manual data input 860. The authorized staff can record in the billing database log 320 to indicate the billing sent to payor 870 and an expected payment date. The billing modules 800 can be configured to send the billing sent to payor 870 information to the report generator 290 and for example produce an account receivables report for management. The automatic tracking of billing preparation and other accounting operations configured into the billing database log 320 of FIG. 3 prevents delays in billing for services performed and enables a surgery center to remain current in the billing functions of one embodiment of the present invention.

### Automated Schedule Tracking Module:

FIG. 8B shows a block diagram of an overview flow chart example of the database system for medical back office automated schedule tracking module of one embodiment of the present invention. FIG. 8B shows an automated schedule tracking module 880 which is an example of the automated systems 170 of FIG. 1. The automated schedule tracking module 880 automatically performs real-time queries of the data entry logs 160 to determine whether scheduled tasks 882 have been completed. The scheduled tasks 882 can include credential renewals, pre-op tasks for a scheduled surgery, equipment testing and other time sensitive tasks. When any task is completed task completion input data 884 is recorded in the respective data entry logs 160 of one embodiment of the present invention.

The automated schedule tracking module 880 is configured with a task completion filter 886. The task completion filter 886 automatically performs constant searches of the data entry logs 160 to identify scheduled tasks 882. The scheduled tasks 882 can be configured for example as set deadline dates or dates in advance of the deadline to allow sufficient task completion prior to the deadline date. The task completion filter 886 identifies incomplete tasks 890 and automatically sends alerts 660 to designated staff 668 of FIG. 6 to complete the tasks immediately. The automated schedule tracking module 880 prevents for example staff from losing credential certifications or scheduled operations in the surgery center from falling behind and disrupting the flow of activities of one embodiment of the present invention.

### Pre-Op Log:

FIG. 9A shows a block diagram of an overview flow chart example of the surgery center database software pre-op log of one embodiment of the present invention. FIG. 9A shows the pre-op log 300 shown in FIG. 3. The pre-op log 300 can be configured to record all the information required to get a patient approved for surgery. The pre-op log 300 can for example include scheduling and pertinent information to manage patients 900 and manage patient care coordinators 905. The preparation for surgery can include for example schedules and results of laboratory work-up 910, imaging work-up 914, imaging 918, nutritional evaluations 920, psychologic evaluations 925, supporting letters 930, pictures 934 and other patient approval procedures 938 of one embodiment of the present invention. Bariatric Pre-Op Log:

FIG. 9B shows a block diagram of an overview flow chart example of the surgery center database software bariatric pre-op log of one embodiment of the present invention. FIG. 9B shows the bariatric pre-op log 305 shown in FIG. 3 which can be configured as an advanced module for approval of bariatric patients for various surgeries. The bariatric pre-op log 305 streamlines the processes and requested information gathering based on different insurance companies. The bariatric pre-op log 305 keeps track of the multiple workup and assessments requested in order to successfully submit a procedure request to an insurance company. The bariatric pre-op log 305 incorporates customized data entry logs 160 of FIG. 1 and automated systems 170 of FIG. 1 which can be configured to provide alerts on any time sensitive events and tracking to ensure appropriate follow-up is done of one embodiment of the present invention.

The bariatric pre-op log 305 can be configured for recording patient BMI, height and weight 940, psychological assessment 945, ordering laboratory workup 950, abnormal results alerts 955, ordering ultrasound workup 960, nutritional assessment 965, a HL7 link to existing practice manager 970 to automatically transfer existing patient demographics, processing insurance files 975, supporting documents and letter of medical necessity 980, insurance company rejection or approval notification 985 and other bariatric patient approval procedures 990 of one embodiment of the present invention.

### Management Administrative Reporting Module:

FIG. 10 shows a block diagram of an overview flow chart of an example of the database system for medical back office management administrative reporting module of one embodiment of the present invention. The database system for medical back office 100 of FIG. 1 includes the management administrative reporting module 180 which is a powerful digital tool to manage the day to day and long term needs of one or more surgery center 110 of FIG. 1. FIG. 10 shows the management administrative reporting module 180 shown in FIG. 3. The management administrative reporting module 180 can be configured to include subroutines 270 that can include the search engine 280, data queries 285 and report generator 290 features of the real-time customizable modular programming structure 130 of FIG. 1 of one embodiment of the present invention.

The surgery center managers and administrators can access customized performance reports that provide the status of desired automated real-time filtered data extractions which for example includes patient tracking 1000, pathology tracking 1005, laboratory tracking 1010, surgery center logs 1015, current sales tracking 1020 and forecasting reports, numbers and types of procedures performed 1030, bariatric surgery information 1040 and consults to surgery ratio 1050 for practitioners. Surgery center managers can assess for example the progress and current status of accreditation forms 1060, provider credentialing 1065, ancillary staff credentialing 1070, inventory management 1080 and other information to manage an outpatient surgery center/hospital 1090 of one embodiment of the present invention.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. A surgery center database system for managing the day to day and long term operations of one or more surgery center, comprising:
a database system for medical back office configured to provide a full range of services to manage one or more outpatient surgery center or other type of health care facility such as a hospital using a customizable modular programming structure;
a customizable modular programming structure configured to perform fast processing of vast amounts of data providing comprehensive data search retrieval with flexible filtering by any data field or multiple data fields and configured to include one or more security feature;
one or more security feature configured to include multi-level security processes to protect patient privacy and protect unauthorized access to the database and component modules;
one or more component modules configured to include one or more customizable modules such as data entry logs, automated systems and a management administrative reporting module;
one or more data entry log module configured to record and maintain data for surgery center activities, inventories and operations such as patients, staff, equipment, credentials, treatments, procedures, surgeries and other surgery center activities, inventories and operations;
one or more automated systems configured to monitor and track time sensitive tasks, produce tracking alerts and automatically perform data extraction functions;
a management administrative reporting module configured to track all sectors of the surgery center operations and configured to extract data from various data entry logs to produce customized management reports;
one or more additional database system features configured to enhance the operation of the database system for medical back office with modules to provide custom specialized services; and;
one or more external links configured to provide services such as links to internet mail servers, teleconferencing and links to existing practice managers to transfer patient information into the database system for medical back office.

2. The system of claim 1, wherein the customizable modular programming structure is configured to integrate new additions to quickly interface with the existing program structure and jointly operate with the other multi-tasking functions on a real-time basis.

3. The system of claim 1, wherein the one or more data entry log module is configured to include for example a pre-op log, bariatric pre-op log, pathology log, blood sugar log, urine HCG control log, stress test log, surgical log, OR temperature and humidity log, fluoroscopy log, defibrillator log, narcotics inventory and log, implants and prosthetics log, equipment inventory log, refrigerator log, generator log, credentials log, miscellaneous forms module, billing database log and other customized logs.

4. The pre-op log of claim 3, wherein the pre-op log is configured to include modules to manage patients, patient care coordinators, laboratory work-up, imaging work-up, imaging, nutritional evaluations, psychological evaluations, supporting letters, pictures and other patient approval procedures.

5. The bariatric pre-op log of claim 3, wherein the bariatric pre-op log is configured to include modules for recording patient BMI, height and weight, psychological assessment, ordering laboratory workup, abnormal results alerts, ordering ultrasound workup, nutritional assessment, HL7 link to existing practice manager, processing insurance files, supporting documents and letter of medical necessity, insurance company rejection or approval notification and other bariatric patient approval procedures.

6. The miscellaneous forms module of claim 3, wherein the miscellaneous forms module is configured to include forms involving for example patients, physicians, nurses, anesthesia providers, surgical technicians, consultants, program users, procedures, anesthesia types, breast implants, diagnoses, tests, password change, patient conditions, disposition types, payment types, surgical centers and other customized forms.

7. The billing database log of claim 3, wherein the billing database log is configured to include billing modules to perform one billing status query of procedures data entry log modules.

8. The billing modules of claim 7, wherein the billing modules are configured to include processes to identify billed procedures to alert designated staff to check the collection status progress.

9. The billing modules of claim 7, wherein the billing modules are configured to include processes to identify unbilled procedures to alert designated staff to prepare a billing for the procedure and configured to perform data extraction queries to produce automated data input into a billing form.

10. The system of claim 1, wherein the one or more security feature is configured to include processes to allow the system administrator to manage the security elements of one or more surgery center such as the ability to assign a surgery center identifier code to each center and assign a user identifier code and password to one or more user.

11. The system of claim 1, wherein the one or more security feature is configured to include processes to allow the system administrator to assign log access privileges and assign data log fields privileges to one or more user.

12. The system of claim 1, wherein the one or more security feature is configured to include processes including an automated real time usage tracking system to record log-in, data entry log module access and data log field changes.

13. The system of claim 1, wherein the one or more automated systems are configured to include processes such as an automated data input integrity filter the data information entered by a user is routed through the data input integrity filter to compare the user data entries to data field parameters such as preset field lengths, type of data such as text, or numeric values that are limited to a minimum and maximum value and configured to alert the user when data entries are not compatible with the data field parameters.

14. The system of claim 1, wherein the one or more automated systems are configured to include an automated schedule tracking module processes such as automatically performs real-time queries of the data entry logs to determine whether scheduled tasks have been completed and configured with processes to automatically sends alerts to designated staff to complete the tasks immediately to prevent scheduled operations in the surgery center from falling behind and disrupting the flow of activities.

15. The system of claim 1, wherein the management administrative reporting module is configured to include subroutines to automatically perform data searches, queries and prepare reports to provide the administrative management staff with desired automated real-time filtered data customized performance reports.

16. The customized performance reports of claim 15, wherein the customized performance reports are configured to include for example the status patient tracking, pathology tracking, laboratory tracking, surgery center logs, current sales tracking and forecasting reports, numbers and types of procedures performed, bariatric surgery information and consults to surgery ratio for practitioners and configured to allow surgery center managers to assess for example the progress and current status of accreditation forms, provider credentialing, ancillary staff credentialing, inventory management and other information to manage an outpatient surgery center/hospital.
